(19) United States
(12) Patent Application Publication
(10) Pub. No.: US 2016/0275435 A1
(43) Pub. Date: Sep. 22, 2016

(54) METHOD AND SYSTEM FOR ASSESSING AND MONITORING WORKER COMPETENCE

(71) Applicant: AVENTUR ENERGY CORPORATION, Fort St. John (CA)

(72) Inventors: Terry AVEN, Fort St. John (CA); Sicily AVEN, Fort St. John (CA); Tracy HUNTER, Fort St. John (CA)

(21) Appl. No.: 15/071,017

(22) Filed: Mar. 15, 2016

Related U.S. Application Data
(60) Provisional application No. 62/133,681, filed on Mar. 16, 2015.

(51) Int. Cl. G06Q 10/06

(52) U.S. Cl. CPC G06Q 10/06398; G06Q 10/063114

(57) ABSTRACT

A method and system is provided for monitoring and assessing an employee's skills and qualifications. Qualification criteria for each job junction within an organization or industry can be grouped into qualification categories. These qualification categories can include Quality, Health, Safety and Environment (QHSE) Management system knowledge, Technical Training, Online Awareness Training, Standard Operating Procedure Assessments, and Accountabilities and Skills. This information can be captured and recorded in a database in near real time allowing an employer to monitor the competencies of each employee and track and correct any deficiencies, should they exist.

### CROSS-REFERENCE TO RELATED APPLICATIONS

This application claims priority of U.S. provisional patent application Ser. No. 62/133,681 filed Mar. 16, 2015, which is incorporated by reference into this application in its entirety.

### TECHNICAL FIELD

The present disclosure is related to the field of methods and systems for assessing and monitoring worker competence.

### BACKGROUND

Measuring an employee's skill level and competence has long been important for employers to ensure that the employees have the proper training and certifications to perform the work they are tasked to do. This is particularly important in industries that require specialized certifications and training to ensure worksite safety. Existing systems for monitoring employees typically only monitor one aspect of an employee's competence, or do not adequately capture experience or competencies gained through a previous employer. When incidents happen on a job site it is typically difficult and time consuming to determine whether the employees on site were trained in the appropriate Standard Operating Procedures (SOPs).

It is, therefore, desirable to provide a method and system that is comprehensive, and can monitor all aspects of worker competence unlike current methods as known in the prior art.

### SUMMARY

A method and system is presented assessing and monitoring worker competence. Qualification criteria for each job junction within an organization or industry can be grouped into qualification categories. These qualification categories can include Quality, Health, Safety and Environment (QHSE) Management system knowledge, Technical Training, Online Awareness Training, Standard Operating Procedure Assessments, and Accountabilities and Skills. This information can be captured and recorded in a database in near real time allowing an employer to monitor the competencies of each employee, and track and correct any deficiencies should they exist.

Broadly stated, in some embodiments, the method can be provided for assessing and monitoring an employee's skills and qualifications, wherein the method can comprise of the steps of: determining a list of job functions within the company; determining number of qualification categories; generating a matrix which can comprise: “n” columns representing job functions within the company; “m” rows representing qualification categories; and cells populated with qualification criteria related to each job function and qualification category; assigning a weighting to each qualification criteria within the qualification categories; assigning a second weighting to each qualification category within each job function; and storing information relating to the qualification criteria attained by an individual employee.

Broadly stated, in some embodiments, the method can further comprise the steps of: calculating qualification category figures of merit based on the weighted average of an employee's completed qualification criteria within each qualification category; and calculating a job function figure of merit based on the weighted average of figures of merit for each qualification category in the employee's job function.

Broadly stated, in some embodiments, the method can further comprise the step of updating the employee record as qualification criteria are completed.

Broadly stated, in some embodiments, the method can further comprise the step of updating the record automatically upon completion of a qualification criterion.

Broadly stated, in some embodiments, the method can further comprise the step of comparing an employee's qualification criteria to a set of required criteria to determine whether an employee is suitable for a required task.

Broadly stated, in some embodiments, the method can further comprise the step determining an employee's advancement to a subsequent job function by the completion of the qualification criteria in the current job function.

Broadly stated, in some embodiments, the method can further comprise the step of transferring the employee record to a subsequent employer.

Broadly stated, in some embodiments, a system can be provided for assessing and monitoring an employee's skills and qualifications, the system can comprise: means for determining a list of job functions within the company; means for determining number of qualification categories; means for generating a matrix which can comprise: n columns representing job functions within the company; m rows representing qualification categories; and cells populated with qualification criteria related to each job function and qualification category; means for assigning a weighting to each qualification criteria within the qualification categories; means for assigning a second weighting to each qualification category within each job function; and means for storing information relating to the qualification criteria attained by an individual employee.

Broadly stated, in some embodiments, the system provided can further comprise: means for calculating qualification category figures of merit based on the weighted average of an employee's completed qualification criteria within each qualification category; and means for calculating a job function figure of merit based on the weighted average of figures of merit for each qualification category in the employee's job function.

Broadly stated, in some embodiments, the system provided can further comprise means for updating the employee record as qualification criteria are completed.

Broadly stated, in some embodiments, the system provided can further comprise means for updating the record automatically upon completion of a qualification criterion.

Broadly stated, in some embodiments, the system provided can further comprise means for comparing an employee's qualification criteria to a set of required criteria to determine whether an employee is suitable for a required task.

Broadly stated, in some embodiments, the system provided can further comprise means for determining an employee's advancement to a subsequent job function by the completion of the qualification criteria in the current job function.

Broadly stated, in some embodiments, the system provided can further comprise means for transferring the employee record to a subsequent employer.

### BRIEF DESCRIPTION OF THE DRAWINGS

FIG. 1 is a flowchart depicting the steps of one embodiment of a method for building a matrix of qualification criteria for job functions within an industry.

FIG. 2 is a flowchart depicting the steps of one embodiment of a method for applying the matrix created in FIG. 1 to determine a figure of merit representing an employee's level of competency within its current job function.

FIG. 3 is a flowchart depicting the steps of one embodiment of a method for updating the matrix created in FIG. 1.

FIG. 4 is a block diagram depicting the components of one embodiment of a system configured to carry out the methods set out in the flowchart of FIGS. 1, 2, and 3.

FIG. 5 is an example of a matrix created in FIG. 1.

### DETAILED DESCRIPTION OF EMBODIMENTS

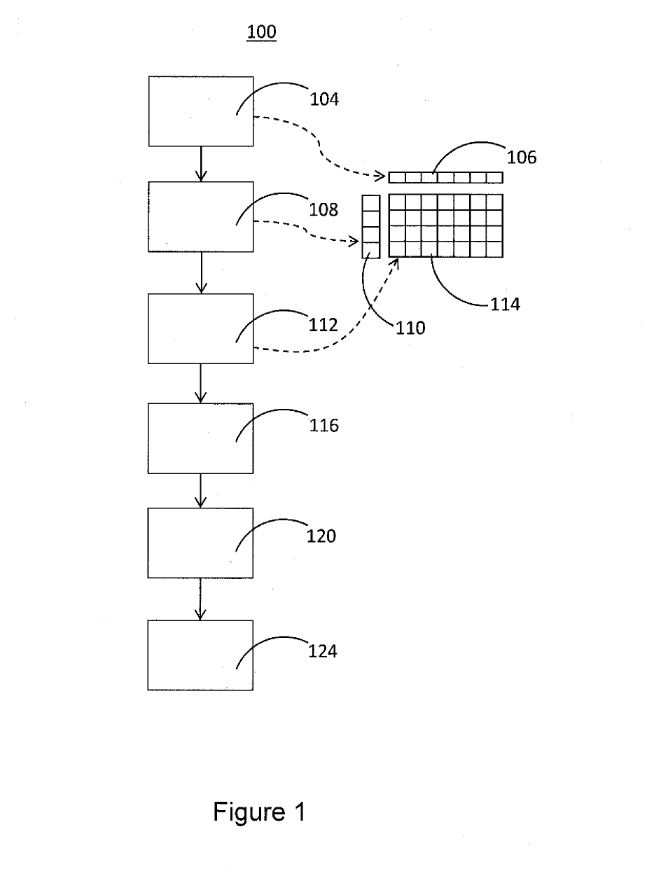

Referring to FIG. 1, the steps of one embodiment of a method for building a matrix of qualification criteria for job functions within an industry is shown as process 100. At step 104, an employer can identify and create a list 106 of the various job functions within the company. Such job functions could be specific to the company, or standardized within an industry.

Once the employer has identified the job junctions within the company, a number of qualification categories can be identified which are applied to the company at step 108. The qualification categories are recorded in list 110. Such categories can include: Quality, Health, Safety & Environment (QHSE) Management system knowledge, Technical Training, Online Awareness Training, Standard Operating Procedure Assessments, and Responsibilities Accountabilities and Skills. The qualification categories are intended to cover the general competency categories required by the company. The categories can be selected to align with industry training standards promoted by the related industry.

At step 112, a matrix 114 is created consisting of “n” columns, representing the job functions in list 106, and “m” rows, representing the qualification categories in list 110. Each cell can be populated with the qualification criteria associated with each job function and qualification category. As an example, the Technical Training of a specific job junction may require specialized certifications.

A weighting can be assigned to each qualification criteria within a qualification category at step 116. If no weighting is assigned, each of the criteria can be weighted equally. This weighting can be used to determine a figure of merit for a specific qualification category. At step 120, a weighting can also be assigned to each qualification category that can be used to determine a figure of merit for employee in their current job function.

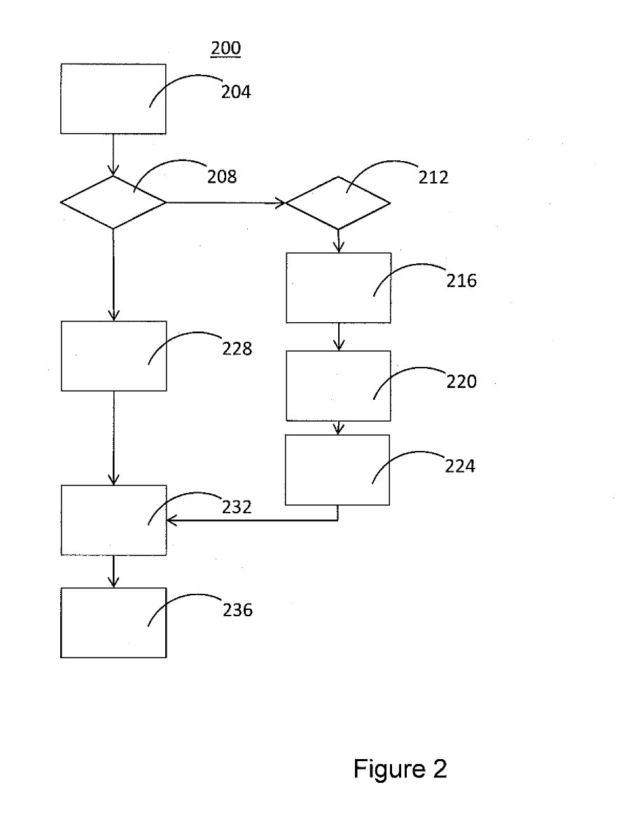

Referring to FIG. 2, the steps of one embodiment of a method for using the matrix 114 generated from Process 100 in FIG. 1, shown as process 200. At step 204, an employee's record can be requested using a given identifier. Such an identifier can be an assigned number, bar code or other unique identifier associated with the employee. The records can be searched to determine if the record is available at step 208. If a record for the employee does not exist, a new record can be created in step 212. Creating a new record can consist of entering an employee's personal information 216 entering the employee's current job function 220, and entering any qualification criteria that the employee is able to provide sufficient evidence of completion 224. If desired, the creation of a new record can be restricted such that only authorized personnel can perform the steps 216 to 228.

Once the Employee record is retrieved in step 228 or created in step 224, a qualification category figure of merit can be calculated based on the weighting of the completed qualification criteria of each qualification category 232. An overall figure of merit for the employee can be calculated based on the weighting of each qualification category figures of merit for the employee 236.

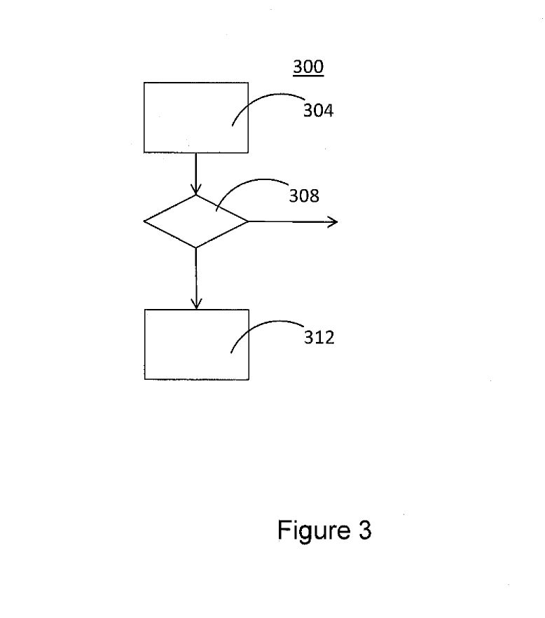

Referring to FIG. 3, the steps for one embodiment of a method for updating the database created in process 100 of FIG. 1 is shown in process 300. The employee's record can be requested in step 304. The database can be searched to determine if the record exists 308. If the record does not exist, the option can be provided to create a new record for the employee following the steps described in FIG. 2, steps 212 to 224. If the record is available, the information relating to the qualification criteria to be updated can be added to the database including the associated evidence regarding the qualification. Evidence of a qualification may be a digital certificate from a computer based training course, an assessment by a supervisor, a certificate of completion of a training course or other evidence as, required. Other information related to the qualification criteria can also be entered such as the expiry date of any certification, and any desired notice to be sent prior to expiry.

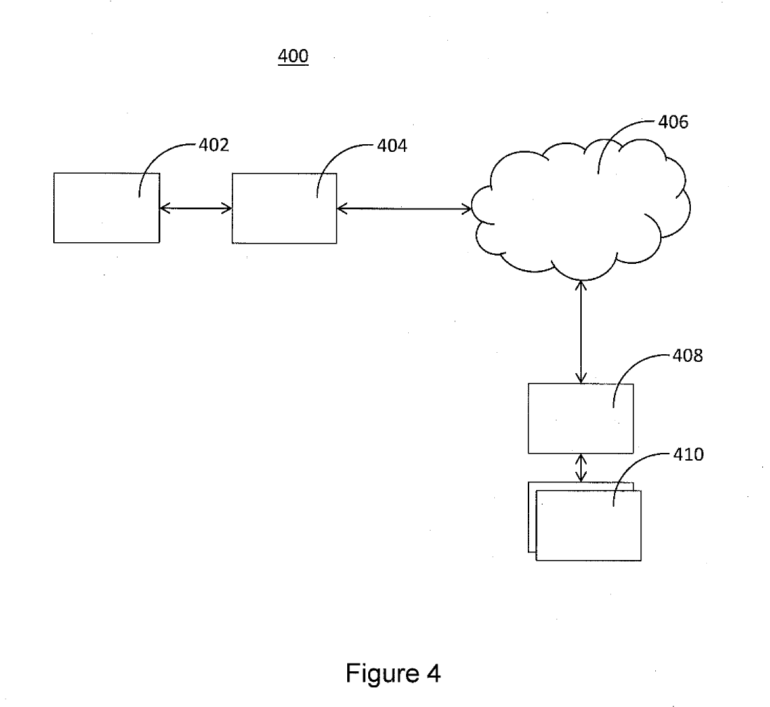

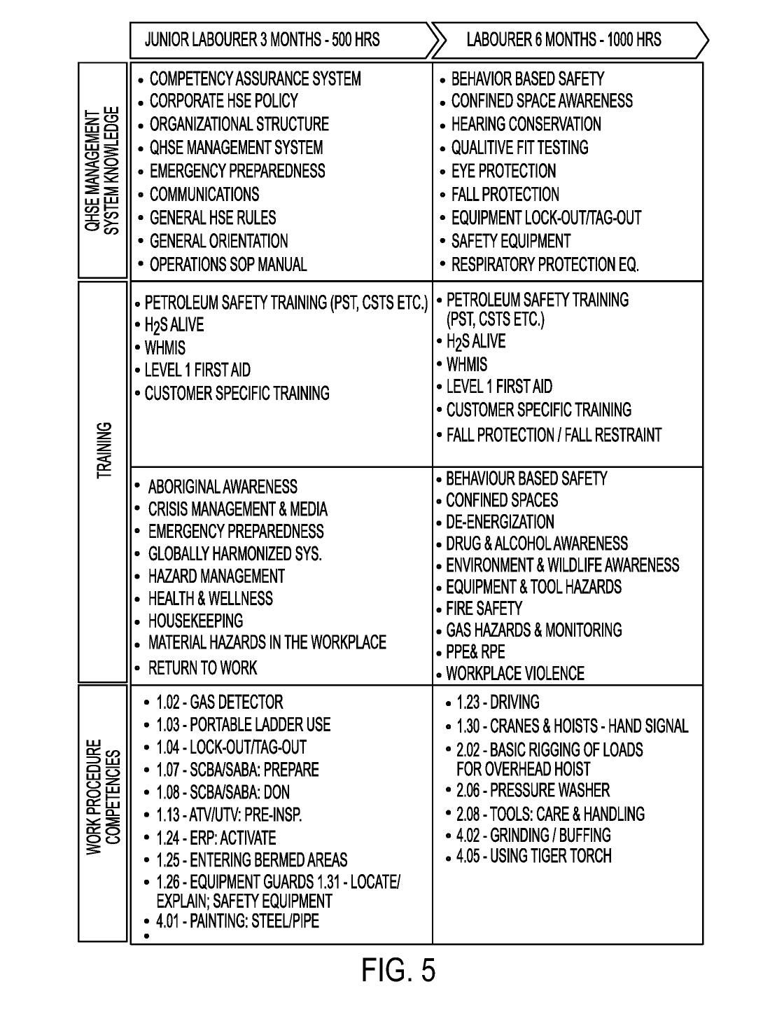

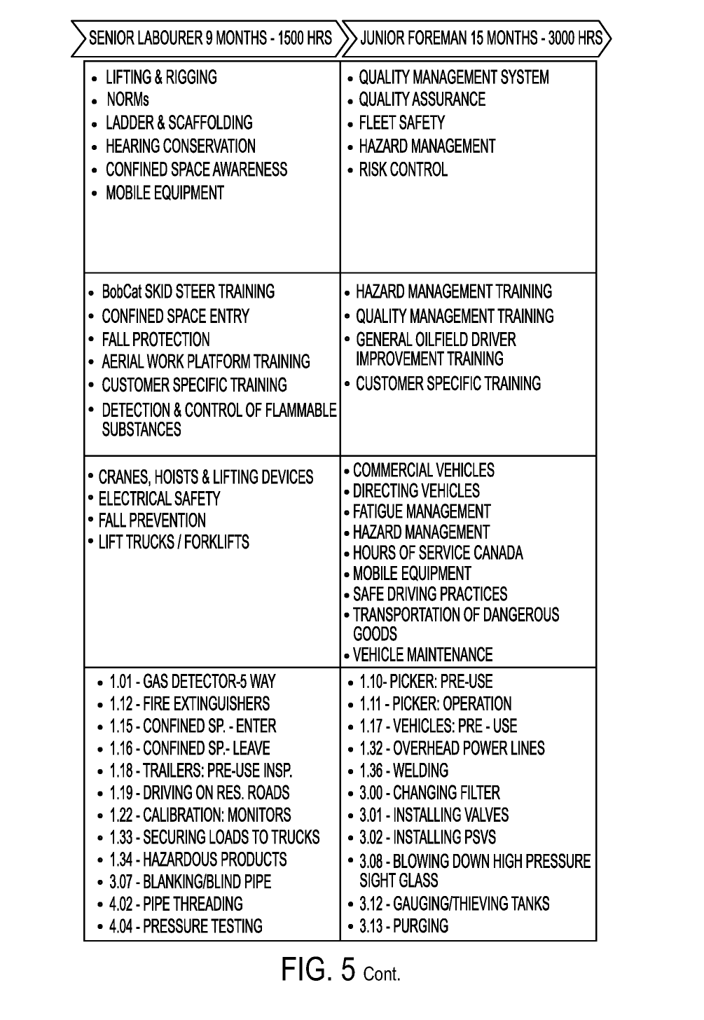

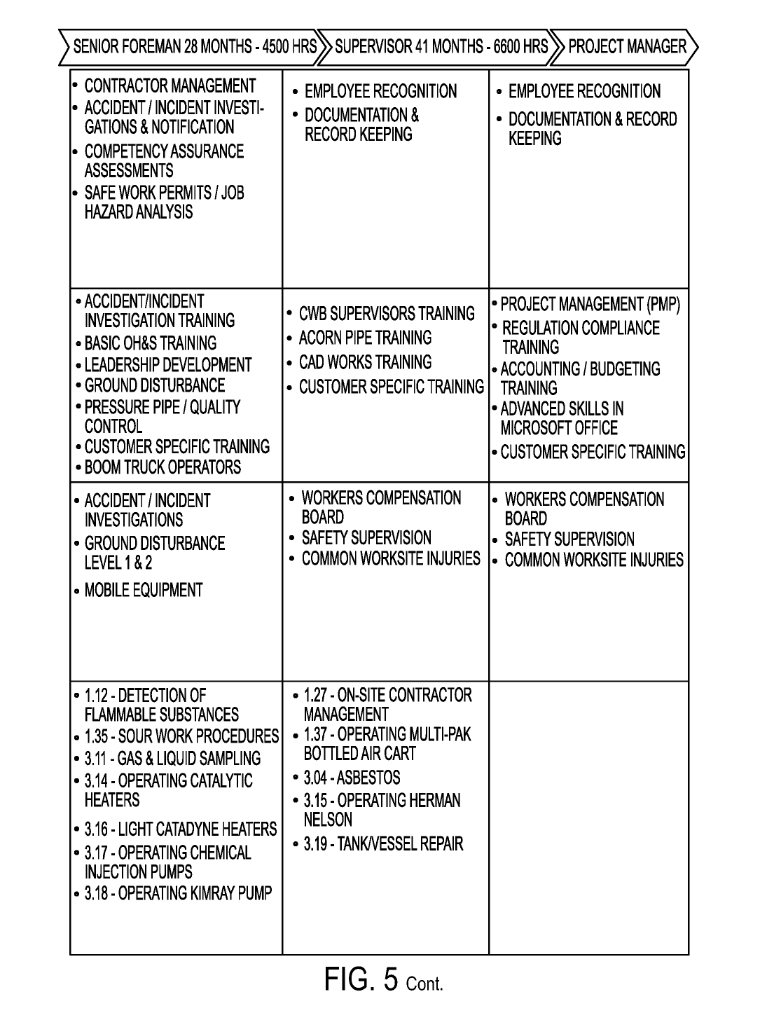

Referring to FIG. 4, a block diagram is shown of system 400 which can carry out the processes 100, 200, and 300. In some embodiments, system 400 can comprise client terminal 402 (such as a personal computer, or other general purpose computing device) comprising or running software application 404, which can be in communication with, or connected to, Internet 406. Internet 406 can provide access to a server network 408 comprising or connected to or in communication with a database 410 configured to store matrix 114 containing a record of an employee's qualification criteria. Server network 408 handles requests for retrieval and updating of the database received from the client.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions, thereof, it being recognized that the invention is defined and limited only by the claims that follow.

We claim:

1. A method for assessing and monitoring an employee's skills and qualifications, the method comprising the steps of:
a) determining a list of job functions within the company;
b) determining number of qualification categories;
c) generating a matrix consisting of:
i) “n” columns representing job functions within the company;
ii) “m” rows representing qualification categories; and
iii) cells populated with qualification criteria related to each job function and qualification category.
d) assigning a weighting to each qualification criteria within the qualification categories;
e) assigning a second weighting to each qualification category within each job function; and
f) storing information relating to the qualification criteria attained by an individual employee.

2. The method as set forth in claim 1, further comprising the steps of:
a) calculating qualification category figures of merit based on the weighted average of an employee's completed qualification criteria within each qualification category; and
b) Calculating a job function figure of merit based on the weighted average of figures of merit for each qualification category in the employee's job function.

3. The method as set forth in claim 1, further comprising the step of updating the employee record as qualification criteria are completed.

4. The method as set forth in claim 3, further comprising the step of updating the record automatically upon completion of a qualification criterion.

5. The method as set forth in claim 1, further comprising the step of comparing an employee's qualification criteria to a set of required criteria to determine whether an employee is suitable for a required task.

6. The method as set forth in claim 1, further comprising the step determining an employee's advancement to a subsequent job function by the completion of the qualification criteria in the current job function.

7. The method as set forth in claim 1, further comprising the step of transferring the employee record to a subsequent employer.

8. A system for assessing and monitoring an employee's skills and qualifications, the system comprising of:
a) means for determining a list of job functions within the company;
b) means for determining number of qualification categories;
c) means for generating a matrix consisting of:
i) n columns representing job functions within the company;
ii) m rows representing qualification categories; and
iii) cells populated with qualification criteria related to each job function and qualification category.
d) means for assigning a weighting to each qualification criteria within the qualification categories;
e) means for assigning a second weighting to each qualification category within each job function; and
f) means for storing information relating to the qualification criteria attained by an individual employee.

9. The system as set forth in claim 8, further comprising of:
a) means for calculating qualification category figures of merit based on the weighted average of an employee's completed qualification criteria within each qualification category; and
b) means for calculating a job function figure of merit based on the weighted average of figures of merit for each qualification category in the employee's job function.

10. The system as set forth in claim 8, further comprising means for updating the employee record as qualification criteria are completed.

11. The system as set forth in claim 10, further comprising means for updating the record automatically upon completion of a qualification criterion.

12. The system as set forth in claim 8, further comprising means for comparing an employee's qualification criteria to a set of required criteria to determine whether an employee is suitable for a required task.

13. The system as set forth in claim 8, further comprising means for determining an employee's advancement to a subsequent job function by the completion of the qualification criteria in the current job function.

14. The system as set forth in claim 8, further comprising means for transferring the employee record to a subsequent employer.
